(19) United States
(12) Patent Application Publication
(10) Pub. No.: US 2022/0276178 A1
(43) Pub. Date: Sep. 1, 2022

(54) SYSTEM AND PROCESS FOR DIAMOND AUTHENTICATION

(71) Applicant: GOLDWAY TECHNOLOGY LIMITED, Hong Kong (CN)

(72) Inventors: Ka Wing CHENG, Hong Kong (CN); Yau Shuen YIU, Hong Kong (CN); Juan CHENG, Hong Kong (CN); Koon Chung HUI, Hong Kong (CN)

(73) Assignee: GOLDWAY TECHNOLOGY LIMITED, Hong Kong (CN)

(21) Appl. No.: 17/633,178

(22) PCT Filed: Aug. 5, 2020
(86) PCT No.: PCT/CN2020/107051

§ 371 Date: Feb. 4, 2022

(30) Foreign Application Priority Data
Aug. 5, 2019 (HK) 19127778.9

(51) Int. Cl. G01N 21/87; G01N 21/64

(52) U.S. Cl. CPC G01N 21/87; G01N 21/6408; G01N 21/645; G01N 2021/6463

(57) ABSTRACT

A process for determining the type of a diamond, wherein the type of diamond is determined by the steps of (i) measuring the fluorescence lifetime characteristics of colour centres of a diamond of unknown type (110a); and (ii) determining the type of diamond by comparing the fluorescence lifetime characteristics measured at step (i) with the fluorescence lifetime characteristics of colour centres of known diamond types (120a), wherein the fluorescence lifetime characteristics of colour centres are indicative of the physical properties of a diamond, which are indicative of the type of a diamond.

### TECHNICAL FIELD

The present invention relates to a process and system for determining properties of a diamond. particularly, the present invention provides a process and a system for authentication and determining the type of a diamond.

### BACKGROUND OF THE INVENTION

As is known, diamonds are typically considered to be luxury item and are often utilized in luxury goods, such as items of jewellery, and are known to often be of a very high value. As such, diamond authentication has become increasingly important with the rise of new technologies in respect of synthetic diamonds and the manufacture thereof.

A natural diamond is typically considered a rare item, and natural diamonds have been reported as having been formed between millions and 3.5 billion years ago, and being formed with the earth, and have been reported as being formed at depths between 150 and 250 kilometers below the surface of the earth.

As is known, the clarity, cut, carat and colour of a diamond influence the value of a diamond. Diamonds of higher value are typically those of very little or no discernable colour, which is typically a subtle yellow tinge, and of higher clarity, that is with fewer visible defects or inclusions with the body of the diamond.

In more recent years, synthetic or non-natural diamonds have been produced, which a formed or grown in a laboratory, and man-made, which are made in a controlled laboratory environment that purported to reflect the conditions needed for diamonds to form in nature. There are two processes to create man-made diamonds; chemical vapor deposition (CVD diamonds) and high-pressure high treatment (HPHT diamonds).

A CVD (chemical vapor deposition) diamond is a laboratory made diamond, which is created through the process of chemical vapor deposition. This method is often used for large stones.

An HPHT (high pressure high temperature) diamond is a laboratory made diamond used with a process called high pressure high treatment. HPHT is primarily used for small diamond melee, not usually for larger stones.

Laboratory made diamonds are considered to be real diamonds, and are comprised of mineral consisting of pure carbon crystallized in the isometric system, and the differences are indistinguishable to the naked eye and nearly if not impossible under magnification.

Such synthetically formed diamonds are considered to be “real”, and grading authorities may issue one report for natural diamonds and a separate report for laboratory made diamonds. Both reports provide a full 4Cs assessment for cut, clarity, color, and carat. All diamonds undergo the same rigorous grading process.

Non-natural (i.e. laboratory made) diamonds are generally of a lower economic value, and can be considered non-authentic or at least non-traditional.

As part of the value of a natural diamond, the age, millions or billions of years, and the scarcity and unique nature between every diamond, drives the value of such diamonds. Further, the history of a diamond also may contribute to its value, and at least sentimental value when a diamond has been gifted or passed down through generations in a family.

Not surprisingly, the advent of high quality synthetically formed diamonds, such as CVP and HPHT diamonds, has had a significant effect in the diamond industry.

There have been instances of natural diamonds being replaced with synthetic diamonds, as part of fraudulent activities, with the real owner not being aware of such deceit.

There have been numerous instances of high-quality synthetic diamonds being passed off to customers as being real diamonds, or real diamonds having full 20 documentation being substituted by synthetic diamonds between purchase and collection.

Traditionally, optical methods, such as Fourier transform infrared (FTIR) and Raman spectroscopies have been utilised to seek to distinguish natural diamonds from synthetic diamonds effectively.

However, due to the great advance in CVD and HPHT technologies for synthetic diamonds in recent years, making discernment increasingly difficult between the different types.

Furthermore, some low-grade natural diamonds can even be treated with HPHT to become high grade diamonds, thus modifying the value of a diamond whilst 30 representing the diamond to be naturally occurring at that grade.

Therefore, diamond authentication so as to determine the type of diamonds, that is natural and unmodified diamonds, versus synthetic or modified natural diamonds, has become increasingly difficult, and existing processes for determining diamond type are increasingly less reliable and uncertain and inevitably shall become obsolete in the near future. Therefore, new methodologies to identify natural, synthetic and treated diamonds are needed.

### OBJECT OF THE INVENTION

It is an object of the present invention to provide a process and a system for authentication of a diamond and type of diamond, which overcomes or at least partly ameliorates at least some deficiencies as associated with the prior art.

### SUMMARY OF THE INVENTION

In a first aspect, the present invention provides a process for determining the type of a diamond, wherein the type of diamond is determined by the steps of:

(i) measuring the fluorescence lifetime characteristics of colour centres of a diamond of unknown type, and
(ii) determining the type of diamond by comparing the fluorescence lifetime characteristics measured at step (I) with the fluorescence lifetime characteristics of colour centres of known diamond types;
wherein the fluorescence lifetime characteristics of colour centres are indicative of the physical properties of a diamond, which are indicative of the type of a diamond.

The physical properties may include inclusions, defects, crystallinity inconsistency, deformation of crystal lattice. Internal stress, internal stress, impurities and uniformity.

The types of diamond may be natural diamonds chemical vapor deposition (CVD) synthetic diamonds, high pressure high temperature (HPHT) synthetic diamonds, and treated natural diamonds.

The process may provide for distinguishing a natural diamond from a synthetic 25 diamond. The synthetic diamond may be a CVD (chemical vapor deposition) diamond.

The colour centre may be an NV centre, SiV centre, or an NVN centre.

In a second aspect, the present invention provides process for identifying whether a diamond is natural diamond or CVD (chemical vapor deposition) diamond, by 30 measuring the fluorescence lifetime of colour centres, wherein the fluorescence lifetime of colour centres of the diamond of the physical properties of a diamond.

The physical properties are indicative of the type of the diamond.

The measurement he fluorescence lifetime of colour centres of the diamond may be effected by a confocal laser scanning fluorescence microscope provided with a time correlated single photon counter module.

The confocal law scanning fluorescence microscope may include a pulsed laser excitation module; a diamond sample stage; an objective lenses; a focusing stabilizer; a laser scanning module; a time correlated single photon counter module; and an emission filter.

The confocal laser scanning microscope may be operated in laser scanning mode.

The pulsed laser excitation module may be composed of picosecond pulsed green laser of wavelength for example 510 nm, 514 nm or 532 nm.

The pulsed laser excitation module may be further provided with a linear polarizer and half wave plate for controlling laser power and an acoustic optical modulator for laser shutter.

The diamond sample stage may be composed of an XYZ 3-axis electrically motorized mechanical stage and a XYZ 3-axis piezo stage for achieving sample scanning.

The objective lens may be an oil immersed type for illuminating laser onto diamond and collect the resultant fluorescence from the diamond.

The objective lens may be with numerical aperture equal to or greater than 1.3.

The focusing stabilizer is preferably for fine control of distance between the diamond sample and the objective lens.

The laser scanning module is preferably consisted of a galvanomirror setup.

The time correlated single photon counter module is for counting arrival time of fluorescence photon after the diamond being excited by a single excite focusing stabilizer is for fine control of distance between the sample and the objective lens.

The colour centres may be NV centres, SiV centres or NVN centres.

The type of diamond may be determined upon a predetermined threshold of correlation of the fluorescence lifetime characteristics of the diamond measured at step (i) with the fluorescence lifetime characteristics of a known diamond type having been met.

In a second aspect, the present invention provides a process operable using a computerized system for determining the type of a diamond, wherein the fluorescence lifetime characteristics of colour centres of a diamond of unknown type is correlated with fluorescence lifetime characteristics of colour centres of a plurality of diamonds each of known type, the computerized system including a fluorescence lifetime data acquisition system a processor module and an output module operably interconnected together, said process including the steps of:

(i) acquiring via a fluorescence lifetime data acquisition system, data indicative of fluorescence lifetime characteristics of colour centres of a diamond of unknown type;
(ii) in a processor module, comparing said data indicative of fluorescence lifetime characteristics of colour centres of the diamond of unknown type image with a plurality of data sets each of which corresponds to fluorescence lifetime characteristics of colour centres of a plurality diamonds each of known type, wherein data sets of fluorescence lifetime characteristics of colour centres of a diamonds of known types are each derived from a fluorescence lifetime acquisition system; and
(iii) from an output module, responsive to a predetermined threshold of correlation between the data derived from step (i) and one of the plurality of data sets from step (ii), an output signal is provided indicative of the type of the diamond, and wherein the fluorescence lifetime characteristics of colour centres of the diamond are indicative of the physical properties of a diamond, which are indicative of the type of a diamond.

In a third aspect, the present invention provides a process operable using a computerized system for determining the type of a diamond using a pre-trained neural network for determination of a diamond type, the computerized system including a fluorescence lifetime data acquisition system, a pre-trained neural network and an output module operably interconnected together via a communication link, said process including the steps of:

(i) acquiring via the fluorescence lifetime data acquisition system data indicative of fluorescence lifetime characteristics of colour centres of a diamond of unknown type;
(ii) in a pre-trained neural network, determining the type of diamond of said diamond of unknown type from the data indicative of fluorescence lifetime characteristics of colour centres of the diamond of unknown type acquired in step (i);
wherein the pre-trained neural network has been pre-trained utilising a plurality of data sets each of which corresponds to fluorescence lifetime characteristics of colour centres of a plurality diamonds each of known type; and
   (iii) from an output module, providing the type of said diamond.

In a fourth aspect, the present invention provides a computerized system for determining the type of a diamond wherein the fluorescence lifetime characteristics of colour centres of a diamond of unknown type is correlated with fluorescence lifetime characteristics of colour centres of a plurality of diamonds each of known type, the computerized system including:

a fluorescence lifetime acquisition system for acquiring data indicative of fluorescence lifetime characteristics of colour centres of a diamond of unknown type
a processor module for comparing said data indicative of fluorescence lifetime characteristics of colour centres of the diamond of unknown type image with a plurality of data sets each of which corresponds to fluorescence lifetime characteristics of colour centres of a plurality diamonds each of known type; and
an output module for providing an output signal indicative of the type of said diamond of unknown type, upon a predetermined threshold of correlation between said data indicative of fluorescence lifetime characteristics of colour centres of a diamond of unknown type and one of the plurality of data sets which corresponds to fluorescence lifetime characteristics of colour centres of a plurality diamonds each of known type.

### BRIEF DESCRIPTION OF THE DRAWINGS

In order that a more precise understanding of the above-recited invention can be 30 obtained, a more particular description of the invention briefly described above will be rendered by reference to specific embodiments thereof that are illustrated in the appended drawings. The drawings presented herein may not be drawn to scale and any reference to dimensions in the drawings or the following description is specific to the embodiments disclosed.

FIG. 1a shows a schematic representation of an example of the process of the present invention;

FIG. 1b shows a schematic representation of an example of a system of the present invention;

FIG. 1c is a diagrammatic representation of a model of the nitrogen vacancy in the diamond lattice as utilised in the present invention;

FIG. 2 shows a graphical representation of fluorescence spectrum of a single NV center in diamond excited with 514 nm;

FIG. 3 is a diagrammatic representation of fluorescence and fluorescence photocycle;

FIG. 4 shown a diagrammatic representation of excitation of NV centers of a bulk diamond;

FIG. 5 shows a schematic representation of the synchronization of Zeiss LSM880 and PicoQuant TCSPC as used in the experimental procedure of the present invention;

FIG. 6 is a schematic representation of the determination of fluorescence lifetime measurement of color centers in diamonds, as utilised in accordance with the present invention;

FIG. 7 shows an enlarged photographic representation of fluorescence lifetime image of CVD diamond;

FIG. 8 shows a decay curve of fluorescence from colour centres in diamond, as utilised in accordance with the present invention; and

FIG. 9 shows a flow charge which described the general process of an embodiment of the present invention.

### DETAILED DESCRIPTION OF THE DRAWINGS

The present inventors have identified shortcomings in the prior art, have provided a system and process which overcomes the problems of the prior art.

For the purposes of this invention, the term “type” of diamond is defined as and is understood to be natural diamonds, chemical vapor deposition (CVD) synthetic diamonds, high pressure high temperature (HPHT) synthetic diamonds, and treated natural diamonds, all of which are different types of diamonds.

### 1. Background of Invention

In order to identify whether a diamond is natural or not such as a CVD or a HPHT diamond, or is a natural diamond which may have been treated to have its properties altered, the physics inside the material can be utilized to make such a determination as to the type of diamond.

Diamond contain impurities, and by understanding the physical properties of the impurities in accordance with the present invention the manner in which the diamond is formed may be formed, and such phenomena and the determination and use thereof, has been provided by the present invention in order to ascertain the type of a diamond.

Accordingly, the present invention provides a process and a system determining the type of a diamond.

The type of diamond, such as natural diamond, chemical vapor deposition (CVD) synthetic diamonds, high pressure high temperature (HPHT) synthetic diamonds, and treated natural diamonds can be determined.

In particular, the present invention is useful in determining whether a diamond is a naturally occurring diamond, or whether the diamond is a synthetic diamond, or a treated diamond

The type of diamond is determined by:
(i) measuring the fluorescence lifetime characteristics of colour centres of a diamond of unknown type; and
(ii) determining the type of diamond by comparing the fluorescence lifetime characteristics measured at step (i) with the fluorescence lifetime characteristics of colour centres of known diamond types;

The fluorescence lifetime characteristics of colour centres are indicative of the physical properties of a diamond, which are indicative of the type of a diamond.

As such, the type of diamond can be determined upon a predetermined threshold of correlation of the fluorescence lifetime characteristics of the diamond measured at step (i) with the fluorescence lifetime characteristics of a known diamond type having been met.

Such threshold may be determined by mathematical analysis, or by a processor, or an automatic computer operable process.

Alternatively, a pre-trained artificial intelligence system may be used, utilising pre-trained neural network. In such a case, the pre-trained neural network is trained using a plurality of data sets each of which corresponds to fluorescence lifetime characteristics of colour centres of a plurality diamonds each of known type; and via an output module, providing the type of said diamond upon receiving data indicative of fluorescence lifetime characteristics of colour centres of a diamond of unknown type.

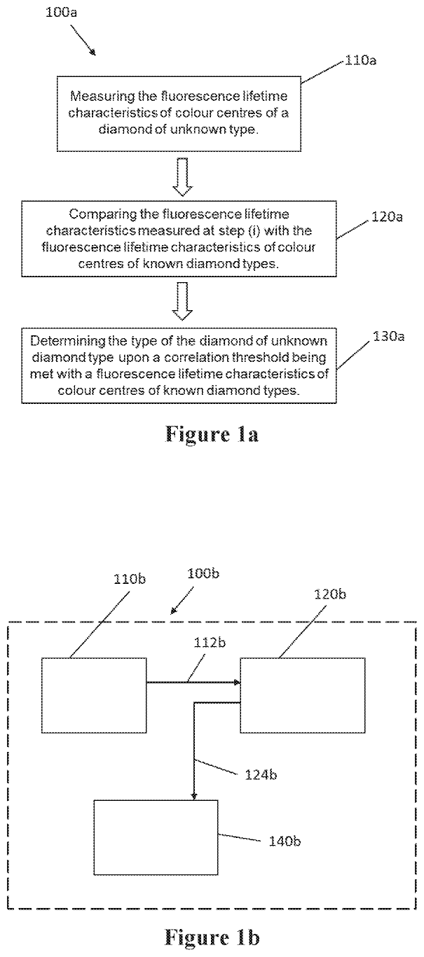

Referring to FIG. 1a, there is a flow chart of the process 100a according to the present invention. As will be understood, the process can be implemented in a computerized system, and further in embodiments the process may utilise a pre-trained neural network.

In the process 100a, the following steps apply for determining the type of diamond is determined by:

Step 1 (110a)—measuring the fluorescence lifetime characteristics of colour centres of a diamond of unknown type;
Step 2 (120a)—comparing the fluorescence lifetime characteristics measured at step (i) with the fluorescence lifetime characteristics of colour centres of known diamond types; and
Step 3 (130a) determining the type of the diamond of unknown diamond type upon a correlation threshold being met with a fluorescence lifetime characteristics of colour centres of known diamond types.

Referring to FIG. 1b, there is shown an example of a computerized system 100b according to the present invention.

The system 100b is for determining the type of a diamond wherein the fluorescence lifetime characteristics of colour centres of a diamond of unknown type is correlated with fluorescence lifetime characteristics of colour centres of a plurality of diamonds each of known type.

The system 100b includes a fluorescence lifetime acquisition system 110b for acquiring data indicative of fluorescence lifetime characteristics of colour centres of a diamond of unknown type.

The system 100b further includes a processor module 120b in communication 112b with the fluorescence lifetime acquisition system 110b and for comparing said data indicative of fluorescence lifetime characteristics of colour centres of the diamond of unknown type image with a plurality of data sets each of which corresponds to fluorescence lifetime characteristics of colour centres of a plurality diamonds each of known type.

The system 100b further includes an output module 140b In communication 124b with the a processor module 120b and for providing an output signal indicative of the type of said diamond of unknown type, upon a predetermined threshold of correlation between said data indicative of fluorescence lifetime characteristics of colour centres of a diamond of unknown type and one of the plurality of data sets which corresponds to fluorescence lifetime characteristics of colour centres of a plurality diamonds each of known type.

### 2. Nitrogen-Vacancy (Nv) Centres of Diamonds

Diamond colour centre has gained attention in quantum technologies, especially for nitrogen-vacancy (NV) centres.

Diamond NV centre is a point defect in the diamond lattice. As is shown in FIG. 1, an NV center of a diamond consists of a carbon atom in the tetrahedral structure being replaced by a nitrogen atom 110 and an adjacent lattice site left empty, which is known as a vacancy 120.

The diamond NV centre can emit fluorescence under light excitation in a suitable wavelength, for example 450 nm-650 nm.

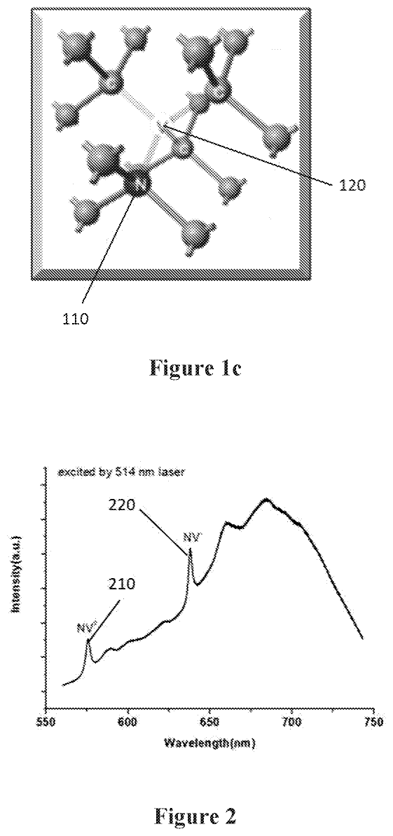

Referring to FIG. 2, there is shown a graphical representation of fluorescence spectrum of a single NV center in the diamond, wherein the NV center of the diamond is excited with a laser having a wavelength of 514 nm.

The fluorescence spectrum relates the intensity of the emitted fluorescence (in arbitrary unit) to the wavelengths thereof. It can be shown in FIG. 2 that there exists two peaks 210 and 220 in the graph at wavelengths of around 575 nm and 635 nm. The peak 210 shows the emitted fluorescence from NV⁰ centers; while the peak 220 shows the emitted fluorescence from NV-centers.

### 3. Fluorescence Lifetime and Photocycle as Utilised in the Present Invention

The fluorescence lifetime is a measure of the time a fluorophore spends in the excited state before returning to the ground state by emitting a photon.

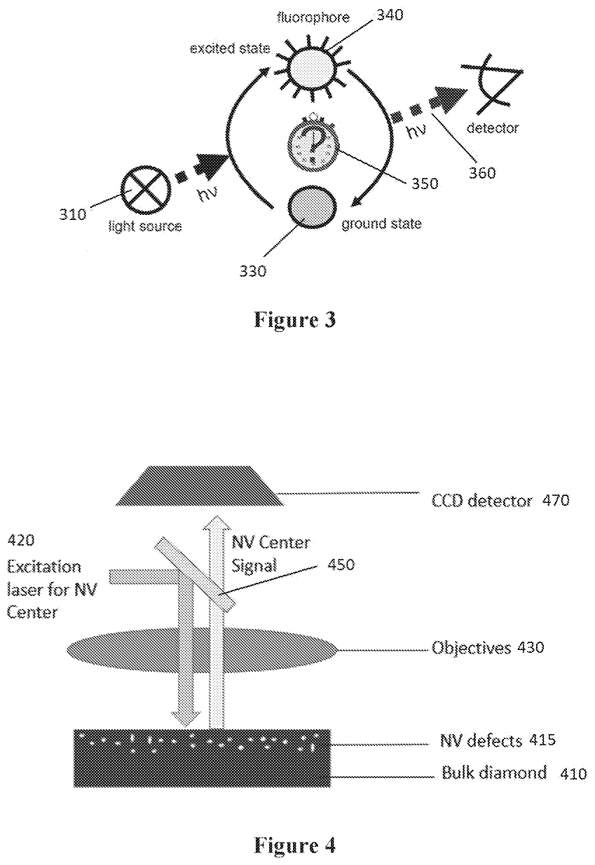

Referring to FIG. 3, the fluorescence and fluorescence photocycle is shown.

Fluorescence photocycle is the process in which visible light is emitted from fluorescent materials a period of time after it is excited by an energy source. As is shown in FIG. 3, the photocycle starts by applying a light source 310 to a fluorescence particle. This allows the fluorescence particle 330 to absorb light which matches with its absorption spectrum, and thereby is excited to its electronic excited state from its ground state.

The excited fluorescent particle, also known as fluorophore 340, will remain at its electronic excited state for a certain period of time 350. After such period 350, the excited fluorescent particle 340 decays back to its electronic ground state by releasing energy 360 of the absorbed light usually in the form of phonon and photon.

The certain period of time 350 after which the excited fluorescent particle 340 decays back to the ground state is referred to as the fluorescence lifetime. The emitted photons during the decay are optically visible and together they form the emitted fluorescence.

In order to measure the emitted fluorescence of an article, in particular the fluorescence emitted by a bulk diamond with NV defects, the experimental setup as shown in FIG. 4 is utilized.

FIG. 4 illustrates the excitation and fluorescence emission process, for excitation of NV centres of a bulk diamond material.

During the excitation process, an excitation laser 420 is applied to the system, which reflects off from a light filter 450, reaches a bulk diamond 410 through an objective lens 430. The laser 420 serves as an energy excitation to the NV centers 415 within the bulk diamond 410.

The light filter 450 only permits the transmission of a fluorescence signal, therefore any incoming light other than fluorescence will be reflected off from the light filer 450.

Upon excited by the laser 420, fluorescence is emitted from the NV centers 415 when they decay back from the excited state to the ground state. The emitted fluorescence is then collected by the same objective lens 430.

The light filter 450 allows the transmission of a fluorescence signal and therefore any fluorescence emitted by the NV centers 415 can reach and be measured by an optical sensor 470 which is this embodiment is a CCD sensor.

The optical sensor 470 detects the intensity of the collected fluorescence signal, as well as the wavelength of such a signal, and therefore providing a graphical fluorescence spectrum similar to that as shown in FIG. 2.

### 4. Present Invention

For a natural diamond, since its formation process was in a scale of millions years, it normally has a relatively lower internal strain and stress.

By comparison, for a CVD (chemical vapor deposition) diamond, such a diamond typically has a larger internal strain and stress than that a natural diamond.

Moreover, since a synthetic diamond has a shorter formation time than natural diamond, a synthetic diamond typically exhibits more homogenous physical properties than a natural diamond.

Further, different types of diamonds have physical properties including inclusions, defects, crystallinity inconsistency, deformation of crystal lattice, impurities and uniformity

The present inventors have identified that all these conditions can affect the fluorescence lifetime for a diamond, and have accordingly proposed an invention for determining the type of a diamond, in particularly whether a diamond is a natural diamond or a CVD diamond.

Thus, the present inventors have a provided a process and system for utilization in determining the type of a diamond, which is based upon fluorescence lifetime.

### 5. Experimental Procedure of Present Invention

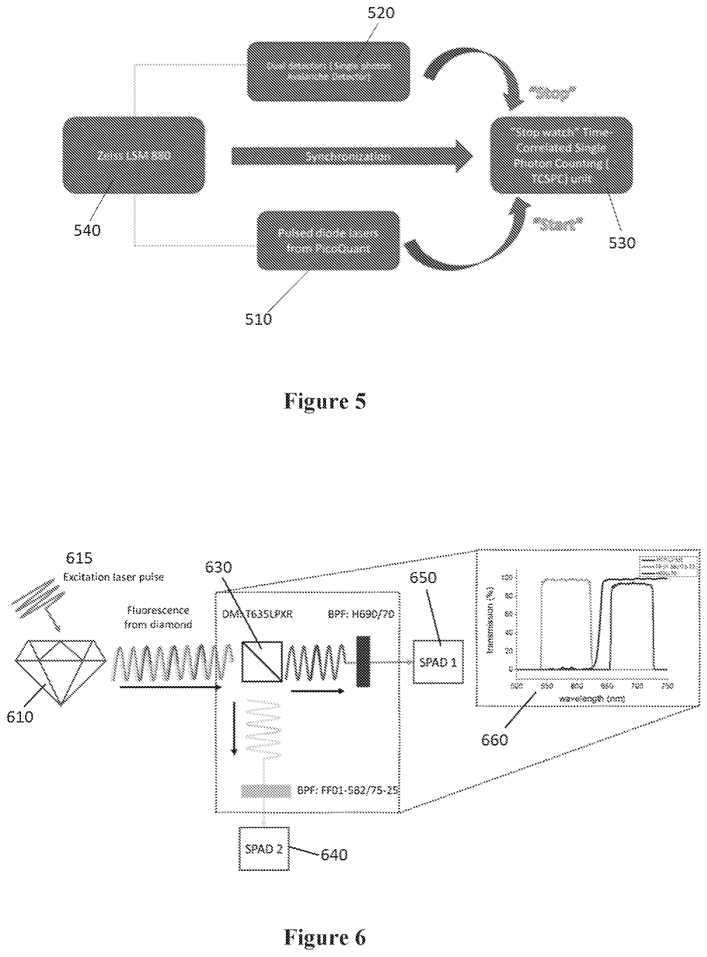

Referring to FIG. 5 and FIG. 6, in order to validate and confirm the usefulness of the present invention for the determination and assessment of diamond type, the fluorescence properties of the NV-centres were investigated using an upgraded system of Zeiss LSM 880 confocal Microscope with Elyra system for super resolution imaging and PicoQuant TSCPC for lifetime measurement.

FIG. 5 is a flow chart showing the experimental procedures for the measurement of fluorescence lifetime. This can be achieved by counting the time-correlated single photons.

As is shown in FIG. 5, the sample to be measured is excited by the pulsed diode lasers with a high repetition rate by the PicoQuant module 510. Photons emitted by the sample are detected with dual detectors 520 and the time with respect to the excitation pulse is measured.

The excited samples then undergoes fluorescence emission, wherein photons are emitted until the samples return completely back to the electronic ground state. As time passes, most of the excited particles have returned to the ground state and therefore the number of photons emitted also decays with time. A Time-Correlated Single Photon Counting (TCSPC) 530 is used as a ‘stop watch’ to measure the decay time.

By counting many events a histogram of the photon distribution over time is built up, which is also known as a decay curve. The fluorescence lifetime is then the time constant of the decay curve after curve fitting.

The NV-centres were investigated using an upgraded system of Zeiss LSM 880 confocal microscope 540.

FIG. 6 further illustrates a schematic representation of the determination of fluorescence lifetime measurement of color centers in diamonds with the procedures used in FIG. 5.

The measurement conditions are listed as follows:
Samples” lightBox CVD diamonds and natural diamonds
Excitation wavelength: 510 nm
Repetition rate: 5 MHz (signal in each channel decays completely in each repetition cycle)
Objective lens: oil immersed NA 1.3, 40×

The optical filters being used include T635LPXR, FF01-582/75.25 and H690/70. The experiment began with a continuous wavelength laser at 514 nm with Main beam splitter T80/R20 was used to locate the Diamond NV-centers. Pre-scan of NV-centers in bulk diamond then will be carried out by focus 5 um into the sample, in an area of 78.8×78.8 um2 and resolution of 512×512 pixels.

Upon the application of an excitation laser pulse 615 onto the diamond 610, fluorescence light including green fluorescence (from NV⁰ state), red fluorescence (from NV-state) are emitted from the NV centers of the diamond 610, with the back-scattered laser light in the background. The emitted light (together with the background) is then split into two channels: green fluorescence and red fluorescence by a beam splitter 630, which in this embodiment is T635LPXR.

The green fluorescence signal, which is emitted from NV⁰ centers, is to be detected by a SPAD 2 detector 640; while the red fluorescence signal which originates from NV-centers is detected by a SPAD 1 detector 650. The collected back-scattered laser was then further filtered by H690/70 and FF01-582/75-25 filters for each corresponding detectors 640 and 650. The graph 660 shows the light transmission percentage through the three optical filters T635LPXR, FF01-582175-25 and H690/70. Beam splitter 630, which in this embodiment is T635LPXR, only allows transmission of light with wavelength between 625 nm to 750 nm and therefore effectively separate the green fluorescence signal from the red fluorescence signal.

Optical filter FF01-582/75-25 permits transmission for greenlight signal, while optical filter H690/70 only allows red light signal to transmit through, and therefore blocking any back-scattered laser to be received at the SPAD 1 and SPAD 2 detectors 640 and 650.

By evaluating the signal received at the SPAD 1 detector 640 and the SPAD 2 detector 650 respectively, with the experimental procedures as shown in FIG. 5, the decay time for the emitted fluorescence from NV⁰ centers and NV-centers can be obtained.

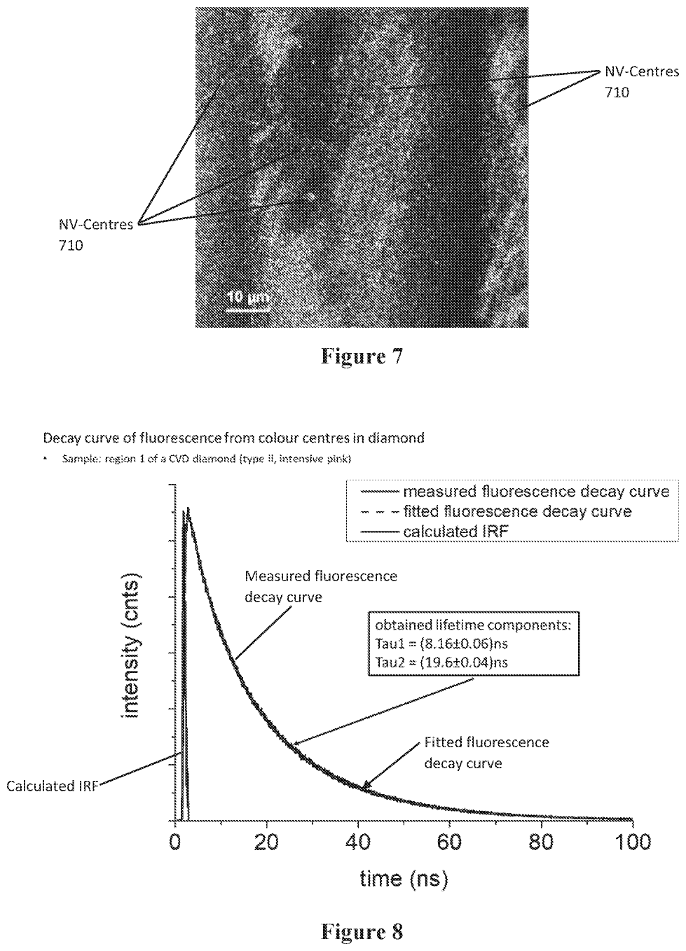

The NV-defects 710 can be successfully excited via the sideband using 510 nm argon laser as can be seen in FIG. 7. After that, a pulse wavelength of 510 nm is applied to excite the NV-center via the strong photon sideband at pulse rate of 10 MHz for 5 minutes.

TCSPC is then applied to record the time decay and determine fluorescence lifetimes of NV-centres upon optical excitation by the short light pulse as shown in FIG. 8.

FIG. 8 is a decay curve of fluorescence from colour centers in diamond correlating the intensity of the fluorescence with time. The sample utilized in this graph is a CVD diamond (Type 11, with intensive pink colour).

It is a profiled method based on repetitive, precisely timed registration of single photons of a fluorescence signal. It measures the time between sample excitation by a pulsed laser and arrival of the emitted photon at the detector.

The measurement of the time between the laser pulse started and the detectors received the arrival signal of the emitted photons, which are repeated for several time to collect the statistical characteristics of fluorophore emission. Afterwards, the delay times are sorted into occurrence emission vs time histogram after the excitation.

### 6. Validating Data of Experimental Procedure of Present Invention

Table 1 below shows fluorescence lifetime measurement results of CVD and natural diamonds.

TABLE 1

| | FLUORESCENCE LIFETIME | |
|---|---|---|
| | tau ± Δtau | |
| | Tau | Δtau |
| DIAMOND TYPE | (ns) | (ns) |

CVD - SYNTHETIC DIAMOND

| | | |
|---|---|---|
| CVD 1 (CVD, II, fancy vivid orange | 6.74 | 0.21 |
| pink) | | |
| CVD 2 (CVD, II, fancy intense pink) | 7.60 | 0.80 |
| CVD 3 (CVD, II, fancy intense pink) | 6.85 | 0.12 |
| CVD 4 (CVD, II, colourless) | 6.69 | 0.25 |
| CVD 5 (CVD, II, colourless) | 8.29 | 0.34 |
| CVD 6 (CVD, II, fancy greenish blue) | 8.57 | 1.99 |
| CDV 7 (CVD, II, fancy greenish blue) | 9.13 | 0.54 |

NATURAL DIAMOND

| | | |
|---|---|---|
| Natural 1 (natural, II) | 11.12 | 1.44 |
| Natural 2 (natural, IaaB) | 11.34 | 0.61 |

For the natural diamond measured in the table, it has a longer fluorescence lifetime at approximately 11 ns (nano seconds) because of the lower strain comparing with <10 ns in CVD diamonds.

For the uniformity difference, since the natural diamonds are more heterogeneous (i.e. less homogeneous), they have larger lifetime variations and vice versa in the CVD diamonds.

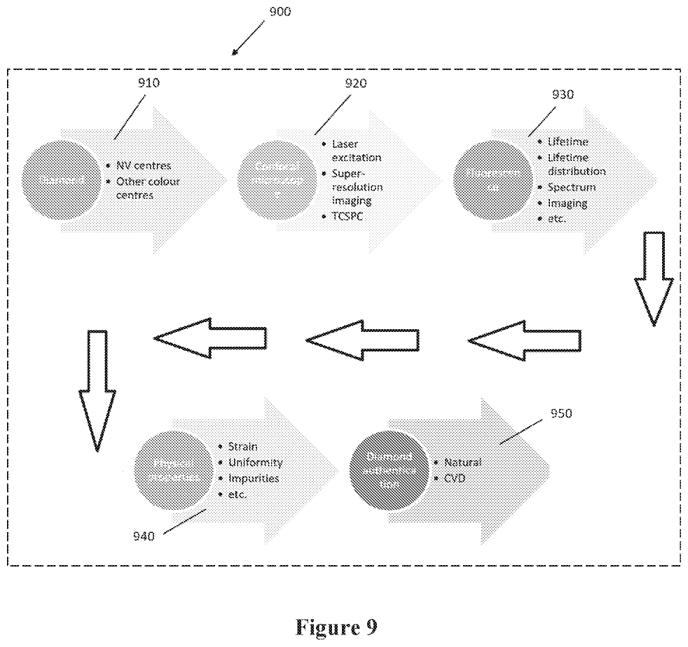

Referring to FIG. 9 there is shown a flow chart which described the general process 900 of an embodiment of the present invention, as a process for determining whether a diamond is a natural diamond or a synthetic diamond.

### Colour Centers (910)

In accordance with the invention, the fluorescence lifetime of the NV centers or other colour centers of a diamond 910 is used for determining the type of diamond.

### Excitation (920)

A diamond of unknown type is excited under a confocal microscope 920, typically by a laser of a predetermined and appropriate wavelength. The excited diamond causes fluorescence from the laser, and the fluorescence lifetime is measured and recorded by TCSPC.

### Emitted Fluorescence Characteristics (930)

The characteristics of the emitted fluorescence 930 including the lifetime distribution, the shape of the spectrum is can also be examined and analyzed in the present invention.

### Influence of Physical Prooerties (940)

The fluorescence lifetime of the NV centres or other colour centres are influenced by the physical properties 940 of the diamond, such as inclusions, defects, crystallinity inconsistency, deformation of crystal lattice, internal stress, internal stress, impurities and uniformity.

Those physical properties vary between types of diamonds, such as natural diamonds, synthetic CVD or HPHT diamonds, treated natural diamonds, treated CVD or HPHT diamonds.

### Determination of Diamond Type (950)

Thus, the decay curves of intensity of fluorescence versus time have characteristics indicative of the type of diamond, thus allowing for assessment of the type of diamond 950 in accordance with the present invention.

The present invention provides a process system and methodology for determining or ascertaining the type of a diamond based upon its fluorescent lifetime decay after excitation due to the physical characteristics of the diamond.

This is achieved by analysis of the fluorescence lifetime decay based on emissions from color centers within the diamond body, whereby it has been found by the present inventors that the decay curve of a natural diamond is different to that of a synthetically formed diamond and as such, the present invention provides a noninvasive assessment process whereby based on Fluorescence lifetime decay following excitation of the color centers of a diamond can be used to determine whether a diamond is a naturally occurring diamond, or whether such a diamond may in fact be synthetically formed in a laboratory such as a CVD diamond.

Synthetic diamonds has provided under current manufacturing conditions, can be very difficult to discern from a natural diamond due to enhanced and in increased manufacturing technologies and as such, the optical properties of such a synthetic diamond often cannot be ascertained as being different from those from a naturally occurring diamond.

Accordingly, the present invention provides a process by which natural diamonds and synthetic diamonds maybe determined as being different from each other, which is useful for various reasons, including impropriety, theft, replacement of diamonds, synthetic diamonds being passed off as being natural diamonds, and valuation of diamonds in order to determine whether a diamond is indeed naturally formed or synthetically formed.

As will be appreciated, he process according to the present invention may be implemented in various forms and embodiments and systems which embody the process, whilst utilizing the present invention in order to determine florescence lifetime so as to distinguish whether a diamond is a naturally occurring diamond or a synthetically laboratory or industry grown diamond.

1. A process for determining the type of a diamond, wherein the type of diamond is determined by the steps of:
(i) measuring the fluorescence lifetime characteristics of colour centres of a diamond of unknown type; and
(ii) determining the type of diamond by comparing the fluorescence lifetime characteristics measured at step (i) with the fluorescence lifetime characteristics of colour centres of known diamond types;
wherein the fluorescence lifetime characteristics of colour centres are indicative of the physical properties of a diamond, which are indicative of the type of a diamond.

2. The process according to claim 1, wherein the physical properties include inclusions, defects, crystallinity inconsistency, deformation of crystal lattice, internal stress, internal stress, impurities and uniformity.

3. The process according to claim 1, wherein the types of diamond are natural diamonds, chemical vapor deposition (CVD) synthetic diamonds, high pressure high temperature (HPHT) synthetic diamonds, and treated natural diamonds.

4. The process according to claim 1, wherein the process provides for distinguishing a natural diamond from a synthetic diamond.

5. The process according to claim 4, wherein the synthetic diamond is a CVD (chemical vapor deposition) diamond.

6. The process according to claim 1, wherein the colour centre is a NV centre, SiV centre, or an NVN centre.

7. A process identifying whether a diamond is natural diamond or CVD (chemical vapor deposition) diamond, by measuring the fluorescence lifetime of colour centres, wherein the fluorescence lifetime of colour centres of the diamond of the physical properties of a diamond.

8. The process according to claim 7, wherein the physical properties are indicative of the type of the diamond.

9. The process according to claim 1, wherein the measurement of the fluorescence lifetime of colour centres of the diamond is effected by a confocal laser scanning fluorescence microscope provided with a time correlated single photon counter module.

10. The process according to claim 9, wherein the confocal laser scanning fluorescence microscope includes:
a pulsed laser excitation module;
a diamond sample stage;
an objective lenses;
a focusing stabilizer;
a laser scanning module;
a time correlated single photon counter module; and
an emission filter.

11. The process according to claim 9, wherein the confocal laser scanning fluorescence microscope is operated in laser scanning mode.

12. The process according to claim 10, wherein the pulsed laser excitation module is composed of picosecond pulsed green laser of wavelength for example 510 nm, 514 nm or 532 nm.

13. The process according to claim 12, wherein the pulsed laser excitation module is further provided with a linear polarizer and half wave plate for controlling laser power and an acoustic optical modulator for laser shutter.

14. The process according to claim 10, wherein the diamond sample stage is composed of an XYZ 3-axis electrically motorized mechanical stage and a XYZ 3-axis piezo stage for achieving sample scanning.

15. The process according to claim 10, wherein the objective lens is oil immersed type for illuminating laser onto diamond and collect the resultant fluorescence from the diamond.

16. The process according to claim 15 wherein the objective lens is with numerical aperture equal to or greater than 1.3.

17. The process according to claim 10, wherein the focusing stabilizer is for fine control of distance between the diamond sample and the objective lens.

18. The process according to claim 10, wherein the laser scanning module is consisted of galvanomirror setup.

19. The process according to claim 10, wherein the time correlated single photon counter module is for counting arrival time of fluorescence photon after the diamond being excited by a single excite focusing stabilizer is for fine control of distance between the sample and the objective lens.

20. The process according to claim 10, wherein the colour centres be NV centres, SiV centres or NVN centres.

21. The process according to claim 1, wherein the type of diamond is determined upon a predetermined threshold of correlation of the fluorescence lifetime characteristics of the diamond measured at step (i) with the fluorescence lifetime characteristics of a known diamond type having been met.

22. A process operable using a computerized system for determining the type of a diamond, wherein the fluorescence lifetime characteristics of colour centres of a diamond of unknown type is correlated with fluorescence lifetime characteristics of colour centres of a plurality of diamonds each of known type, the computerized system including a fluorescence lifetime data acquisition system a processor module and an output module operably interconnected together, said process including the steps of:
(i) acquiring via a fluorescence lifetime data acquisition system, data indicative of fluorescence lifetime characteristics of colour centres of a diamond of unknown type;
(ii) in a processor module, comparing said data indicative of fluorescence lifetime characteristics of colour centres of the diamond of unknown type image with a plurality of data sets each of which corresponds to fluorescence lifetime characteristics of colour centres of a plurality diamonds each of known type, wherein data sets of fluorescence lifetime characteristics of colour centres of a diamonds of known types are each derived from a fluorescence lifetime acquisition system; and
(iii) from an output module, responsive to a predetermined threshold of correlation between the data derived from step (i) and one of the plurality of data sets from step (ii), an output signal is provided indicative of the type of the diamond, and wherein the fluorescence lifetime characteristics of colour centres of the diamond are indicative of the physical properties of a diamond, which are indicative of the type of a diamond.

23. A process operable using a computerized system for determining the type of a diamond using a pre-trained neural network for determination of a diamond type, the computerized system including a fluorescence lifetime data acquisition system, a pre-trained neural network and an output module operably interconnected together via a communication link, said process including the steps of:
(i) acquiring via the fluorescence lifetime data acquisition system data indicative of fluorescence lifetime characteristics of colour centres of a diamond of unknown type;
(ii) in a pre-trained neural network, determining the type of diamond of said diamond of unknown type from the data indicative of fluorescence lifetime characteristics of colour centres of the diamond of unknown type acquired in step (i)
wherein the pre-trained neural network has been pre-trained utilising a plurality of data sets each of which corresponds to fluorescence lifetime characteristics of colour centres of a plurality diamonds each of known type; and
(iii) from an output module, providing the type of said diamond.

24. A computerized system for determining the type of a diamond wherein the fluorescence lifetime characteristics of colour centres of a diamond of unknown type is correlated with fluorescence lifetime characteristics of colour centres of a plurality of diamonds each of known type, the computerized system including:
a fluorescence lifetime acquisition system for acquiring data indicative of fluorescence lifetime characteristics of colour centres of a diamond of unknown type;
a processor module for comparing said data indicative of fluorescence lifetime characteristics of colour centres of the diamond of unknown type image with a plurality of data sets each of which corresponds to fluorescence lifetime characteristics of colour centres of a plurality diamonds each of known type; and
an output module for providing an output signal indicative of the type of said diamond of unknown type, upon a predetermined threshold of correlation between said data indicative of fluorescence lifetime characteristics of colour centres of a diamond of unknown type and one of the plurality of data sets which corresponds to fluorescence lifetime characteristics of colour centres of a plurality diamonds each of known type.
